(19) United States
(12) Patent Application Publication
(10) Pub. No.: US 2026/0216646 A1
(43) Pub. Date: Jul. 30, 2026

(54) FACILITY FOR RECOVERING CO2 CONTAINED IN A FEED GAS FLOW

(71) Applicant: L'Air Liquide, Societe Anonyme pour l'Etude et l’Exploitation des Procedes Georges Claude, Paris (FR)

(72) Inventors: Richard DUBETTIER, Champigny Sur Marne (FR); Martin RAVENTOS, Champigny Sur Marne (FR); Guillaume RODRIGUES, Champigny Sur Marne (FR)

(73) Assignee: L'Air Liquide, Societe Anonyme pour l'Etude et l’Exploitation des Procedes Georges Claude, Paris (FR)

(21) Appl. No.: 18/728,787

(22) PCT Filed: Dec. 22, 2022
(86) PCT No.: PCT/EP2022/087418

§ 371 Date: Jul. 12, 2024

(30) Foreign Application Priority Data
Jan. 14, 2022 (FR) FR2200315

(51) Int. Cl. B01D 53/86; B01D 53/04; B01D 53/047; B01D 53/26

(52) U.S. Cl. CPC B01D 53/8631; B01D 53/0407; B01D 53/0462; B01D 53/0476; B01D 53/261; B01D 2253/108; B01D 2256/22; B01D 2257/404; B01D 2258/0283

(57) ABSTRACT

A plant for recovering CO2 contained in a feed gas flow (FG) having at least 10 ppm NOX, between 10% and 50% vol% CO2, N2, water and O2 with a minimum concentration of 0.1 mol %, the NOX containing NO and NO2. The facility including a compression assembly arranged to compress the feed gas flow, a drying space, preferably placed downstream of the compression assembly, to dry the feed gas flow that has passed through the compression assembly, so as to obtain a dried gas flow (FGS), and an adsorption treatment unit including at least one adsorbent chosen to encourage the oxidation of NO to NO2, the drying space belonging to a dryer placed upstream of the treatment unit, the treatment unit being arranged to treat the dried gas flow coming from the dryer, with a view to producing a CO2-enriched gas flow.

### CROSS-REFERENCE TO RELATED APPLICATIONS

This application is a § 371 of International PCT Application PCT/EP2022/087418, filed Dec. 22, 2022, which claims § 119(a) foreign priority to French patent application FR 2200315, filed Jan. 14, 2022.

### BACKGROUND

### Field of the Invention

The present invention relates to a facility and a process for recovering CO2 (carbon dioxide) contained in a feed gas stream.

### Related Art

NOX (nitrogen oxides) are present in combustion gases in the form of NO (nitrogen monoxide) and NO2 (nitrogen dioxide), in a typical ratio of 90% NO to 10% NO2. Most power plants are equipped with selective catalytic reduction (SCR) units in which NH3 (ammonia) reacts with NO and NO2 to form N2 (dinitrogen) and water (H2O), thus reducing NOX emissions to below hundreds of ppm. These units have to process large amounts of combustion gas.

Not all factories in industries are equipped with SCR systems. For example, a fluid catalytic cracking plant or a cement plant emits around 200 ppm NOX. Steam methane reforming units (SMRs) emit less than 100 ppm NOX. In the context of carbon capture, the obvious solution for a person skilled in the art would be to have a series reduction of the NOx by an SCR and then a CCUS (Carbon dioxide Capture, Utilization and Storage) post-treatment using for example amine to capture the CO2, this technology being on the one hand sensitive to NOx (degradation of the solvent and creation of extremely toxic by-products) and on the other hand being liable to concentrate the NOx emitted into the atmosphere after the CO2 has been captured.

The invention aims in particular to propose a significant reduction of NOX simultaneously with capture of the CO2 in the combustion gases. The invention is not limited to a combustion gas and can be applied to any type of feed gas stream regardless of its origin, this gas stream comprising CO2, NOx and potentially at least one gas that is less adsorbable than CO2, such as N2, O2, Ar, He, H2, etc.

### SUMMARY OF THE INVENTION

A subject of the invention is therefore a facility for recovering CO2 contained in a feed gas stream comprising at least 10 ppm NOX, between 10% and 50% by volume of CO2, N2, water and O2 with a minimum concentration of 0.1 mol %, preferably with a concentration of greater than or equal to 1 mol %, in particular with a concentration of between 2% and 5% or a concentration of greater than 10%, the NOX comprising NO and NO2, the facility comprising:
a compression assembly arranged to compress the feed gas stream, the compression assembly in particular comprising a plurality of compression stages and a plurality of heat exchangers arranged to cool the gas stream compressed by the compression stages, this compression assembly being arranged to compress the gas stream to a pressure of greater than 1.5 bar abs, in particular to a pressure of between 3 and 15 bar abs, or even to a pressure of between 4 and 12 bar abs (the abbreviation “bar abs” means bar absolute),
a drying space, preferably located downstream of the compression assembly, for drying the feed gas stream that has passed through the compression assembly, so as to obtain a dried gas stream,
an adsorption treatment unit comprising at least one adsorbent chosen for promoting the oxidation of the NO to NO2 and arranged to:
   a., the drying space being part of a dryer located upstream of the treatment unit, treat the dried gas stream coming from the dryer, so as to produce a gas stream enriched in CO2, or
   b., the drying space forming part of the treatment unit and comprising a drying adsorbent chosen for adsorbing H2O and located in the treatment unit upstream of the adsorbent chosen for promoting the oxidation of the NO to NO2, treat the gas stream dried beforehand by the drying adsorbent, so as to produce a gas stream enriched in CO2.

In addition to the compounds mentioned above, the feed gas stream may contain other minor constituents such as argon and various impurities depending on the upstream units from which the gas stream originates. In addition, some of the NOX may be present in the form of N2O4 (dinitrogen tetroxide, which is considered equivalent to 2 NO2 in the evaluations).

According to one of the aspects of the invention, the feed gas stream is filtered before being introduced into the compression assembly in order to free it of any possible particles or dust that it might contain. This is because the feed gas stream may, before filtration, contain an excessive amount of particles or dust. This filtration, if necessary, is carried out to a threshold chosen so that the gas stream thus treated by filtration is compatible with the downstream unit(s).

The term “compatible with the downstream units” is understood to mean that residual particles do not cause clogging, deposits or poor distribution that may be detrimental to the proper functioning of the unit. Depending on the case, the thresholds chosen may correspond to particles with dimensions of less than 40 microns, optionally less than 5 microns, and/or a concentration of solid particles of less than 1 mg/m3, optionally less than 0.01 mg/m3 .

In the case where the drying space is part of a dryer upstream of the treatment unit, the dryer may comprise a temperature swing adsorption (TSA) apparatus.

TSA here refers to all units for separating gas by adsorption following adsorption/regeneration cycles such that the regeneration gas is used at least temporarily (heating step) at a temperature greater than the adsorption temperature. The pressure of the regeneration gas is arbitrary: greater than, equal to or, preferentially, less than the adsorption pressure.

This dryer is then an additional apparatus, for example a TSA with only two drying adsorbers and four valves per adsorber. This embodiment of the invention has the advantages of the absence of corrosion problems on the PSA and the fact that the gases resulting from the PSA are dry.

It will be noted that the dryer can be located on the gas exiting from any compression stage, after refrigeration, if this offers an economic advantage.

According to one of the aspects of the invention, the dryer comprises a TEG (TriEthylene Glycol) unit for drying the gas stream.

In the case where the drying space forms part of the treatment unit and comprises a drying adsorbent, there is no apparatus additional to the PSA, but measures must be provided against corrosion due to the possible presence of nitric acid. For example, it is then desirable to use corrosion-resistant materials such as stainless steel.

According to one of the aspects of the invention, the dried gas stream comprises less than 500 ppm H2O, in particular less than 10 ppm, for example less than 1 ppm. The NOX comprises in particular essentially 90% NO and 10% by volume of NO2, before passing through the compression assembly. These ratios may be different, in particular depending on the source of the feed gas stream and the treatments it may have undergone.

In the present invention, the presence of a dryer before the treatment unit is particularly advantageous for avoiding the formation of nitric acid in or downstream of this treatment unit. This makes it possible to avoid damage to equipment such as PSA valves.

The invention makes it possible to limit both the amount of NO in the CO2-enriched stream obtained from the adsorption treatment unit, for example the PSA, and the amount of NO present in the nitrogen-enriched stream at the PSA outlet. To do this, the invention utilizes the catalyst effect of certain adsorbents which promotes the reaction of NO to NO2, in the presence of oxygen. The invention makes it possible to establish conditions favorable for these adsorbents to be fully active over a satisfactory duration. To do this, the invention makes it possible, by virtue of the drying space, to ensure the absence of H2O. This is because H2O could be adsorbed at least partially, which would reduce the activity of the adsorbent. In addition, the presence of NO2 in the presence of H2O can lead to the formation of nitric acid which, depending on the type of adsorbents on the one hand can be adsorbed and significantly reduce the catalytic activity sought, and for certain other types of adsorbents on the other hand can accelerate their destruction. The absence of nitric acid also makes it possible to use conventional materials and avoids damage to sensitive equipment such as valves.

The invention thus enables a significant abatement of NO while allowing the capture of the CO2 resulting from feed gas streams.

The pressure provided by the compression assembly promotes the conversion of NO to NO2.

According to one of the aspects of the invention, the adsorbent is chosen from: a silica gel, a zeolite, activated carbon, an alumina or a combination of these elements.

According to one of the aspects of the invention, the adsorbent chosen for promoting the oxidation of the NO to NO2 comprises a mixture of at least two different silica gels, and/or of at least two different zeolites, and/or of at least two different activated carbons.

Two adsorbents can differ, in a non-exhaustive manner, by their porosity, by the nature of the active sites (in particular for zeolites), by the binder (in terms of nature or amount), by any impurities present (binder, activated carbon, etc.), by post-treatments (ion exchanges, impregnation, washing operations, etc.). Depending on these differences, two adsorbents of the same type may have very substantially different adsorption or catalysis characteristics. This is all the more the case when two parameters differ, such as the composition and the porosity.

The adsorbent is chosen so as not to be substantially degraded by chemical reaction with NOX. Thus, the service life of the adsorbent is greater than 1 year, preferably greater than 2 years, or even 3 years of operation.

The adsorbent of the treatment unit adsorbs CO2 preferentially and N2 is not adsorbed preferentially by this adsorbent, such that most of the nitrogen is extracted at the high pressure of the cycle, in a gas stream depleted in CO2, and so as to obtain one or more gas streams enriched in CO2 during the regeneration of the absorbent mass.

According to one of the aspects of the invention, NO2 is also adsorbed preferentially and NO is not adsorbed preferentially, such that the majority of the NO2 exiting the unit is located in the CO2-enriched stream and the majority of the NO exiting the unit is located in a gas stream rich in N2.

According to one of the aspects of the invention, the adsorbent of the treatment unit chosen is a silica gel or an alumina, or a combination of these two elements.

According to one of the aspects of the invention, the treatment unit comprises at least one additional adsorbent, in addition to the adsorbent that promotes the oxidation of the NO to NO2 described thus far. This additional adsorbent, which does not have the function of promoting the oxidation of the NO to NO2, is for example an adsorbent able to adsorb CO2 and/or NO2.

According to one of the aspects of the invention, at least one item of condensate separation equipment can be provided, in particular after cooling at the outlet of a compression stage.

According to one of the aspects of the invention, the treatment unit comprises a pressure swing adsorption (PSA) apparatus.

The regeneration gas of the TSA-type dryer is generally an N2-rich gas, preferentially extracted from the feed gas stream, that is to say either a fraction of the CO2-depleted stream directly resulting from the PSA, or a purge gas resulting from a unit located downstream of the PSA, for example a cryogenic unit treating the CO2-enriched stream, which still contains a certain amount of N2, for additional CO2 enrichment. The residual N2 fraction will then be extracted, generally at the top of a denitrogenation column, and can be returned to the facility for recovering CO2 that is the subject of the invention.

According to one of the aspects of the invention, the treatment unit comprises a VPSA adsorption apparatus in which the adsorption is effected at a high pressure of greater than atmospheric pressure, in particular between 1.5 and 6 bar abs, and the desorption at a low pressure of less than atmospheric pressure, in particular less than 600 mbar. This pressure is in particular between 200 and 600 mbar abs, or can, where appropriate, essentially reach 50 mbar abs in the case, for example, of a vacuum pump comprising several pumping stages.

According to one of the aspects of the invention, when the drying space is part of a dryer, the stream entering the dryer has been cooled, preferably to between 3 and 20° C., with adequate refrigeration water such as cold water or ice water, which promotes adsorption.

According to one of the aspects of the invention, in particular when the drying space is in the treatment unit, the stream entering the treatment unit has been cooled, preferably to between 3 and 20° C., with adequate refrigeration water such as cold water or ice water.

A subject of the invention is also a process for recovering CO2 contained in a feed gas stream comprising at least 10 ppm NOX, between 10% and 50% by volume of CO2, N2, water, and O2 with a minimum concentration of 0.1 mol %, preferably with a concentration of greater than or equal to 1 mol %, in particular with a concentration of between 2% and 5% or a concentration of greater than 10%, the NOX comprising NO and NO2, the process comprising the following steps:
compressing, with the aid of a compression assembly, the feed gas stream,
then drying, through a drying space, the compressed feed gas stream, so as to obtain a dried gas stream, in particular comprising less than 500 ppm H2O, in particular less than 10 ppm H2O, for example less than 1 ppm H2O, with the aid of an adsorption treatment unit comprising at least one adsorbent chosen for promoting the oxidation of the NO to NO2,
   a., the drying space being part of a dryer located upstream of the treatment unit, treating the dried gas stream coming from the dryer, so as to produce a gas stream enriched in CO2, or
   b., the drying space forming part of the treatment unit and comprising a drying adsorbent chosen for adsorbing H2O and located in the treatment unit upstream of the adsorbent chosen for promoting the oxidation of the NO to NO2, treating the gas stream dried beforehand by the drying adsorbent, so as to produce a gas stream enriched in CO2.

The invention makes it possible to obtain an overall rate of conversion of NO to NO2 via the oxidation of the NO which is greater than 20%, in particular greater than 30% or 50%, or even 75%.

The term “overall rate” is understood to mean that the evaluation is made between the amount of incoming NO measured in the feed gas at the intake of the compression assembly (possibly supplemented by the amount of NO contained in a recycle coming from a unit other than the CO2 recovery unit of the facility of the invention), and the amounts exiting the adsorption treatment unit.

It will be noted that the evaluation at the outlet must be done at least over a full cycle of the PSA.

According to one of the aspects of the invention, CO2 is present in the feed gas stream at a rate of more than 10% by volume, in particular more than 15% or 20% by volume, on a dry basis.

The composition on a dry basis is that defined when the water is removed from the gas. For example, if there is 15 mol % of water in the gas stream, all other compositions in the presence of water should be divided by 0.85 to ultimately make 100% without taking into account H2O.

According to one of the aspects of the invention, NOX is contained in the feed gas stream at a rate of less than 1000 ppmv, in particular less than 500 ppmv or 100 ppmv.

According to one of the aspects of the invention, the NO2/(NO+NO2) ratio, in molar ppm, in the feed gas stream to be treated is less than 50%, in particular less than 20% or 10% or even 5% or 1%.

The gas stream enriched in CO2 resulting from the adsorption treatment unit, for example the PSA or VPSA, can be treated in a downstream unit for additional CO2 enrichment and the CO2-depleted gas from this downstream unit can be recycled upstream of or directly into the adsorption treatment unit, for example the PSA or VPSA, in order to increase the CO2 extraction yield.

The CO2 composition of the CO2-enriched stream from the adsorption treatment unit, for example the PSA or VPSA, can be between 45% and 90% depending on the application.

According to one of the aspects of the invention, the combustion gas stream is a flue gas resulting from the combustion of hydrocarbons.

These flue gases originate for example from a cement kiln or an SMR (Steam Methane Reforming) furnace.

According to one of the aspects of the invention, a fraction of the CO2 contained in the combustion gas can come from the starting material introduced into the furnace to be converted there, for example the CO2 possibly coming from CaCO3.

### BRIEF DESCRIPTION OF THE FIGURES

The invention will be better understood on reading the following description and on studying the accompanying figure. This figure is given only by way of illustration and does not in any way limit the invention.

FIG. 1 is a block diagram illustrating a facility according to one example of implementation of the invention;

FIG. 2 shows schematic curves illustrating the test results of measuring the conversion rate of NO to NO2;

FIG. 3 is a block diagram illustrating a facility according to another example of implementation of the invention.

### DETAILED DESCRIPTION OF THE INVENTION

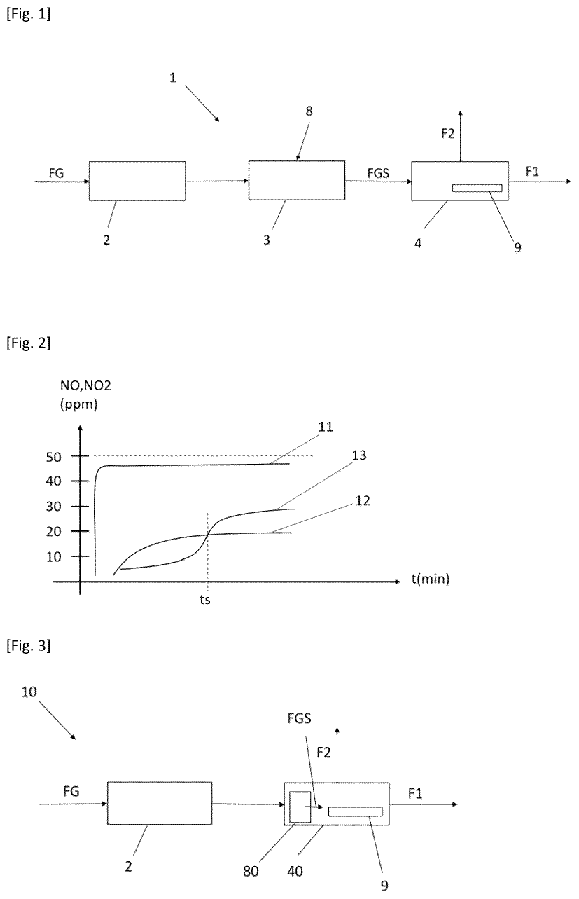

FIG. 1 shows a facility 1 for recovering CO2 contained in a feed gas stream FG comprising at least 10 ppm NOX, between 10% and 50% by volume of CO2, N2, water and O2 with a minimum concentration of 0.1 mol %, preferably with a concentration of greater than or equal to 1 mol %, the NOX comprising NO and NO2, the facility comprising:
a compression assembly 2 arranged to compress the feed gas stream FG, the compression assembly in particular comprising a plurality of compression stages and a plurality of heat exchangers arranged to cool the gas stream compressed by the compression stages, optionally a plurality of items of equipment for removing condensates, this compression assembly 2 being arranged to compress the gas stream to a pressure of greater than 1.5 bar abs, in particular to a pressure of between 3 and 15 bar abs, or even to a pressure of between 4 and 12 bar abs,
a dryer 3 located downstream of the compression assembly 2, for drying the feed gas stream that has passed through the compression assembly, so as to obtain a dried gas stream FGS, this dryer 3 forming a drying space 8 within the meaning of the invention,
an adsorption treatment unit 4 arranged to treat the dried gas stream FGS so as to produce a gas stream F1 enriched in CO2, the treatment unit 4 being installed downstream of the dryer 3 and comprising at least one adsorbent 9 chosen for promoting the oxidation of the NO to NO2.

The feed gas stream FG is formed for example by flue gases originating from a cement kiln or an SMR (Steam Methane Reforming) furnace.

In addition to the compounds mentioned above, the feed gas stream may contain other minor constituents such as argon and various impurities depending on the upstream units from which the gas stream originates. In addition, some of the NOX may be present in the form of N2O4 (dinitrogen tetroxide).

The dried gas stream FGS comprises less than 500 ppm H2O, in particular less than ppm, for example less than 1 ppm.

The NOX comprises in particular essentially 90% NO and 10% by volume of NO2, before passing through the compression assembly.

In the present invention, the presence of the dryer before the treatment unit is particularly advantageous for avoiding the formation of nitric acid in or downstream of this treatment unit.

The invention thus enables a significant abatement of NO while allowing the capture of the CO2 resulting from feed gas streams.

The adsorbent 9 is chosen from: a silica gel, a zeolite, activated carbon, an alumina or a combination of these elements.

For example, the adsorbent 9 chosen for promoting the oxidation of the NO to NO2 comprises a mixture of at least two different silica gels, and/or of at least two different zeolites, and/or of at least two different activated carbons.

The adsorbent 9 is chosen so as not to be substantially degraded by chemical reaction with NOX. Thus, the service life of the adsorbent is greater than 1 year, preferably greater than 2 years, or even 3 years of operation.

The adsorbent 9 of the treatment unit 4 adsorbs CO2 preferentially, and N2 is not adsorbed preferentially by this adsorbent, such that most of the nitrogen is extracted at the high pressure of the cycle, in a gas stream F2 depleted in CO2, and so as to obtain one or more gas streams F1 enriched in CO2 during the regeneration of the absorbent mass.

NO2 is also adsorbed preferentially and NO is not adsorbed preferentially, such that the majority of the NO2 exiting the treatment unit 4 is located in the CO2-enriched stream and the majority of the NO exiting the unit is located in the gas stream enriched in N2.

For example, the treatment unit 4 comprises a pressure swing adsorption (PSA) apparatus.

As a variant, the treatment unit 4 comprises a VPSA adsorption apparatus in which the adsorption is effected at a high pressure of greater than atmospheric pressure, in particular between 1.5 and 6 bar abs, and the desorption at a low pressure of less than atmospheric pressure, in particular of between 200 and 600 mbar abs, or even possibly going down as far as 50 mbar abs.

The dryer 3 comprises a temperature swing adsorption (TSA) apparatus.

The stream entering the dryer 3 has been cooled, preferably to between 3 and 20° C., with adequate refrigeration water such as cold water or ice water, which promotes adsorption.

The stream entering the treatment unit 4 has been cooled, preferably to between 3 and 20° C., with adequate refrigeration water such as cold water or ice water.

The facility 1 makes it possible to implement the following steps:
compressing, with the aid of a compression assembly 2, the feed gas stream,
then drying, with the aid of a dryer 3, the compressed feed gas stream, so as to obtain a dried gas stream, in particular the dryer being arranged such that it produces a dried gas stream comprising less than 500 ppm H2O, in particular less than 10 ppm, for example less than 1 ppm,
treating, with the aid of an adsorption treatment unit 4, the dried gas stream so as to produce a gas stream enriched in CO2, the treatment unit being installed downstream of the dryer and comprising at least one adsorbent 9 chosen for promoting the oxidation of the NO to NO2.

The invention makes it possible to obtain an overall rate of conversion of NO to NO2 via the oxidation of the NO which is greater than 20%, in particular greater than 30% or 50%, or even 75%.

It is recalled that the term “overall rate” is understood to mean that the evaluation is made between the amount of incoming NO measured at the intake of the compression assembly and the amounts exiting the adsorption treatment unit.

CO2 is present in the feed gas stream at a rate of more than 10% by volume, in particular more than 15% or 20% by volume, on a dry basis.

NOX is contained in the feed gas stream FG at a rate of less than 1000 ppmv, in particular less than 500 ppmv or 100 ppmv.

The NO2/(NO+NO2) ratio, in molar ppm, in the feed gas stream FG to be treated is less than 50%, in particular less than 20% or 10% or even 5% or 1%.

The gas stream F1 enriched in CO2 resulting from the adsorption treatment unit 4, for example the PSA or VPSA, can be treated in a downstream unit for additional enrichment and the CO2-depleted gas from this downstream unit can be recycled upstream of or directly into the adsorption treatment unit 4, for example the PSA or VPSA, in order to increase the CO2 extraction yield.

The CO2 composition of the CO2-enriched stream from the adsorption treatment unit, for example the PSA or VPSA, can be between 45% and 90% depending on the application.

It is possible to ensure that an adsorbent is capable of promoting the oxidation of the NO to NO2, for example by virtue of a test that includes the following steps:
regenerating the particles by flushing with dry nitrogen (with a maximum of 1 ppm of water) at 250° C. (or at the maximum recommended temperature where appropriate);
passing a dry nitrogen stream containing a maximum of 1 ppm of water, 50 ppm of NO and 2 mol% of 02, at temperature and pressure that are representative of the process according to the invention, for example at 20° C. and 8 bar abs for a PSA operating at 8 bar abs high pressure cycle and at ambient temperature, through a tube filled with glass beads, the N2 flow rate and the dimensions of the adsorber allowing a contact time of the gas (the contact time being defined below) with the glass beads of approximately 5 seconds;
continuing the flushing until a stable NO content is obtained at the outlet;
calculating the rate of conversion of NO to NO2;
implementing these steps with the same tube filled with the same volume of the adsorbent to be tested;
measuring the NO content at the outlet when this content is stabilized;
calculating the conversion rate;
concluding that the adsorbent is capable of promoting the oxidation of the NO to NO2 if the conversion rate with the adsorbent-filled tube is greater than the conversion rate with the glass bead-filled tube and preferentially retaining adsorbents for which the conversion rate is at least 10 points greater than that obtained by means of glass beads.

The term “contact time” is understood here to mean the time it takes for the gas to pass through the useful zone of the tube (that which will be filled with particles) when it is empty of any material. This sets the gas flow rate to be used during the tests with precision. Under these conditions, a contact time of 5 seconds corresponds to an actual residence time of the gas during a test of about 3 seconds.

The conversion rate in the chemical reaction of oxidation of NO to NO2 is defined as follows. If at the inlet there is an amount of N moles of NO (per unit of time) and M moles at the outlet, with M<N, the conversion rate is (N-M)/N, that is to say the number of moles converted to NO2 divided by the number of moles at the inlet.

In the case of the test defined above, the gas flow rate can be considered to be constant between the inlet and the outlet and the ppm values of NO between the inlet and the outlet can be compared directly.

FIG. 2 shows a result of a test performed under the above conditions. The contents at the outlet of the tube (NO and possibly NO2) are shown on the y axis with the time on the x axis.

The curve referenced 11 corresponds to glass beads or to an adsorbent not having any particular catalyst effect. The NO not being adsorbed exits very rapidly and then remains virtually stable. For this type of product, which is not a catalyst or is a very poor catalyst of the oxidation reaction, the content at the outlet is in the range extending from 47 to 49.5 ppm, for example. The NO2 content, not shown, makes it possible to finalize the evaluation to within measurement uncertainties. Conversion rates are in the range extending from 1% to 6%.

Curves 12 and 13 correspond to the breakthroughs of NO and NO2 respectively over an adsorbent according to the invention. Since NO reacts strongly with oxygen to give NO2 and the latter is adsorbed, a stabilized system is obtained when the adsorbent is saturated at the time referenced (ts). The rate of conversion of NO to NO2, after saturation of the adsorbent, is 60% in this case. An adsorbent can be considered to have a significant effect on conversion when the rate thus determined is equal to more than 20%, i.e. about fifteen points above a practically inert material. Curve 12 also shows that the adsorption of the NO2 formed, before saturation, enables a higher rate of conversion of NO than that obtained subsequently. It can be concluded therefrom that, on the one hand, an over-dimensioning of the layer corresponding to the adsorbent promoting the conversion reaction will increase the average conversion rate and, on the other hand, that said adsorbent mass could advantageously comprise a material promoting the reaction and a material with a high capacity for adsorbing NO2. These two materials can be in the form of intimately mixed particles in the optimal ratio determined by tests. Where appropriate, these two materials can be mixed in the powder state and shaped to give a particle including both a catalysis function and an NO2 adsorption function. The catalysis function can be carried out, for example, by the binder. The mixture of the two materials is then called the “adsorbent”.

In general, according to one of the aspects of the invention, the treatment unit employs an adsorbent the rate of conversion of NO to NO2 of which, as defined above, is greater than or equal to 20%.

According to another aspect of the invention, the treatment unit employs an adsorbent the rate of conversion of NO to NO2 of which, as defined above, is greater than or equal to 30%, preferentially greater than or equal to 50%.

FIG. 3 shows a facility 10 for recovering CO2 according to another example embodiment of the invention, which differs from the facility in the example of FIG. 1 in that the drying space 80 forms part of the treatment unit 40, in this case of PSA type. This drying space 80 comprises a drying adsorbent chosen for adsorbing H2O and located in the treatment unit 40, upstream of adsorbent 9 chosen for promoting the oxidation of NO to NO2. The treatment unit 40 is arranged to treat the gas stream dried beforehand in drying space 80 so as to produce a gas stream enriched in CO2.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise. “Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”. “Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-9. (canceled)

10. A facility for recovering CO2 contained in a feed gas stream comprising at least 10 ppm NOX, between 10% and 50% by volume of CO2, N2, water and O2 with a minimum concentration of 0.1 mol %, the NOX comprising NO and NO2, the facility comprising:
a compression assembly arranged to compress the feed gas stream, the compression assembly comprising a plurality of compression stages and a plurality of heat exchangers arranged to cool the gas stream compressed by the compression stages, this compression assembly being arranged to compress the gas stream to a pressure of greater than 1.5 bar abs,
a drying space, preferably located downstream of the compression assembly, for drying the feed gas stream that has passed through the compression assembly, thus configured to obtain a dried gas stream (FGS),
an adsorption treatment unit comprising at least one adsorbent chosen for promoting the oxidation of the NO to NO2, the drying space being part of a dryer located upstream of the treatment unit, the treatment unit being arranged to treat the dried gas stream coming from the dryer, thus configured to produce a gas stream enriched in CO2.

11. The facility of claim 10, wherein the dried gas stream (FGS) comprises less than 500 ppm H2O.

12. The facility of claim 10, wherein the adsorbent chosen for promoting the oxidation of the NO to NO2 is chosen from the group consisting of: a silica gel, a zeolite, activated carbon, an alumina and a combination of these elements.

13. The facility of claim 10, wherein the adsorbent chosen for promoting the oxidation of the NO to NO2 comprises a mixture of at least two different silica gels, and/or of at least two different zeolites, and/or of at least two different activated carbons.

14. The facility of claim 10, wherein the treatment unit comprises a pressure swing adsorption apparatus.

15. The facility of claim 10, wherein the treatment unit comprises a VPSA adsorption apparatus in which the adsorption is affected at a high pressure of greater than atmospheric pressure, and the desorption at a low pressure of less than atmospheric pressure.

16. The facility of claim 10, wherein the dryer comprises a temperature swing adsorption (TSA) apparatus.

17. A process for recovering CO2 contained in a feed gas stream comprising at least 10 ppm NOX, between 10% and 50% by volume of CO2, N2, water, and O2 with a minimum concentration of 0.1 mol %, the NOX comprising NO and NO2, the process comprising the following steps:
compressing, with the aid of a compression assembly, the feed gas stream,
then drying, through a drying space, the compressed feed gas stream, so as to obtain a dried gas stream (FGS),
with the aid of an adsorption treatment unit comprising at least one adsorbent chosen for promoting the oxidation of the NO to NO2, the drying space being part of a dryer located upstream of the treatment unit, treating the dried gas stream coming from the dryer, thus configured to produce a gas stream enriched in CO2.

18. The process of claim 17, wherein the overall rate of conversion of NO to NO2 via the oxidation of the NO is greater than 20.
